(19) United States
(12) Patent Application Publication
(10) Pub. No.: US 2007/0250383 A1
(43) Pub. Date: Oct. 25, 2007

(54) Paying for placement for advertising on mobile devices

(76) Inventors: Preston Tollinger, Los Altos, CA (US); Brent Dusing, San Jose, CA (US)

Correspondence Address: HELLER EHRMAN LLP, 275 MIDDLEFIELD ROAD, MENLO PARK, CA, 94025-3506, US

(21) Appl. No.: 11/408,599

(22) Filed: Apr. 20, 2006

(51) Int. Cl. G06Q 30/00

(52) U.S. Cl. 705/14

(57) ABSTRACT

A method is provided for delivering advertising items to a client's mobile device. Server software at a host system receives advertising items of an advertising campaign for distribution to clients with mobile devices. A placement order of advertising items is made for the display at a client's mobile device.

### BACKGROUND OF THE INVENTION

1. Field of the Invention

This invention relates generally to systems and methods for delivering advertising and, more particularly, and more particularly to systems and methods for paying for placement for advertising on portable devices.

2. Description of the Related Art

Advertising using traditional media, such as television, radio, newspapers and magazines, is well known. Advertisers have used these types of media to reach a large audience with their advertisements (“ads”). To reach a more responsive audience, advertisers have used demographic studies. For example, advertisers may use broadcast events such as football games to advertise beer and action movies to a younger male audience. However, even with demographic studies and entirely reasonable assumptions about the typical audience of various media outlets, advertisers recognize that much of their ad budget is simply wasted because the target audience is not interested in the ad they are receiving.

Interactive media, such as the Internet, has the potential for better targeting of advertisements. For example, some websites provide an information search functionality that is based on query keywords entered by the user seeking information. This user query can be used as an indicator of the type of information of interest to the user. By comparing the user query to a list of keywords specified by an advertiser, it is possible to provide some form of targeted advertisements to these search service users. An example of such a system is the Adwords system offered by Google, Inc.

While systems such as Adwords have provided advertisers the ability to better target ads, their effectiveness is limited to sites where a user enters a search query to indicate their topic of interest. Most web pages, however, do not offer search functionality and for these pages it is difficult for advertisers to target their ads. As a result, often, the ads on non-search pages are of little value to the viewer of the page and are therefore viewed more as an annoyance than a source of useful information. Not surprisingly, these ads typically provide the advertiser with a lower return on investment than search-based ads, which are more targeted.

As the popularity of the Internet and the World Wide Web has increased over the years, more and more companies are seeking effective advertising solutions in order to promote their products to consumers. One such advertising solution includes the pushing of advertisements to consumers through banners or e-mail. Banner advertisements often include various types of multimedia information, including simple images, which promote products, services, websites, or the like. Although banner advertisements are presented in a wide number of shapes and sizes, they are often shaped similar to a rectangular “banner” anchored to a section of a particular website. When a consumer visits the website, the banner advertisement is pushed to the consumer along with the other information associated with the site. Examples of banner advertisements appear on virtually every commercial Web site on the Internet.

On the other hand, e-mail advertisements include various types of multimedia information formatted into an e-mail message. The consumer's e-mail address is often gathered through a wide number of methods, not all of which are known to, or approved by the consumer. The e-mail address is attached to the e-mail advertisement, and the e-mail is delivered to the consumer. Examples of unsolicited e-mail advertising campaigns are often referred to as online junk mail, or simply spam.

Because of the ineffectiveness of pushing random information to consumers through banner or e-mail advertisements, revenues received from the sale of same continue to decline. Accordingly, online advertisers have applied related concepts of matching, tracking, and predicting, to the information found in these delivery mechanisms. For example, online advertisers may attempt to profile types of consumers who visit a particular website. The profile may be based on the online content of the website, self-reported demographic information of a consumer, or consumer tracking. Self-reported demographic information may include areas of interest, income, occupation, age, race, sex, marital status, or the like. Consumer tracking may include recording information about consumer purchases, preferences, or activities, and sending the information back to the online advertising company. Consumer tracking is often accomplished through the use of small files, or cookies, typically stored on a consumer's computer that retain information about the consumer's purchases, preferences, activities, or the like.

Once the online advertisers create the foregoing consumer profiles, they use the profiles to predict or match which products or services the advertisers believe might be interesting to the consumers. Advertisement information associated with the matched products or services is then pushed to the consumer through the foregoing delivery vehicles of banner or e-mail advertisements.

Another solution by online advertisers attempting to overcome the ineffectiveness of pushing random information to consumers, is the use of opt-in e-mail. Generally, opt-in e-mail allows a consumer to agree to receive e-mail advertisements based on a broad authorization of a topic or category of information. The online advertiser then determines which information to push to the consumer based on the topic or category. For example, a consumer may authorize an advertiser to send e-mail relating to sales or closeouts. In response, the advertiser may push, via e-mail, closeout pricing information for any item the advertiser selects, based on, for example, the foregoing matching, tracking, or predicting solutions.

However, all of the preceding are directed to websites and search engine results. There is a need for the delivery of advertising to mobile devices with a placement order.

### SUMMARY OF THE INVENTION

Accordingly, an object of the present invention is to provide systems and methods for creating advertising campaigns and bidding for the placement order of advertising media on a mobile device.

Another object of the present invention is to provide systems and methods for delivering correct ads or coupons to targeted clients at their mobile devices based on a series of rules and reporting the campaign results back to the advertiser.

Yet another object of the present invention is to provide systems and methods for methods for creating advertising campaigns and bidding for the placement order of advertising media on a mobile device while supporting billing and advertising for an campaign.

These and other objects of the present invention are achieved in a method of delivering advertising items to a client's mobile device. Server software at a host system receives advertising items of an advertising campaign for distribution to clients with mobile devices. A placement order of advertising items is made for the display at a client's mobile device.

In another embodiment of the present invention, a system is provided for delivering advertising items to a client's mobile device. A host system includes a host server. The host server includes resources configured to receive advertising items of an advertising campaign from advertisers for distribution to clients with mobile devices. The system includes a recommendation engine. The recommendation engine makes a determination of placement order of advertising items to be received and displayed at the client's mobile device.

### BRIEF DESCRIPTION OF THE DRAWINGS

FIG. 1 is a schematic diagram of one embodiment of a system of the present invention.

FIG. 2 is an overall flow chart for one embodiment of a method of the present invention.

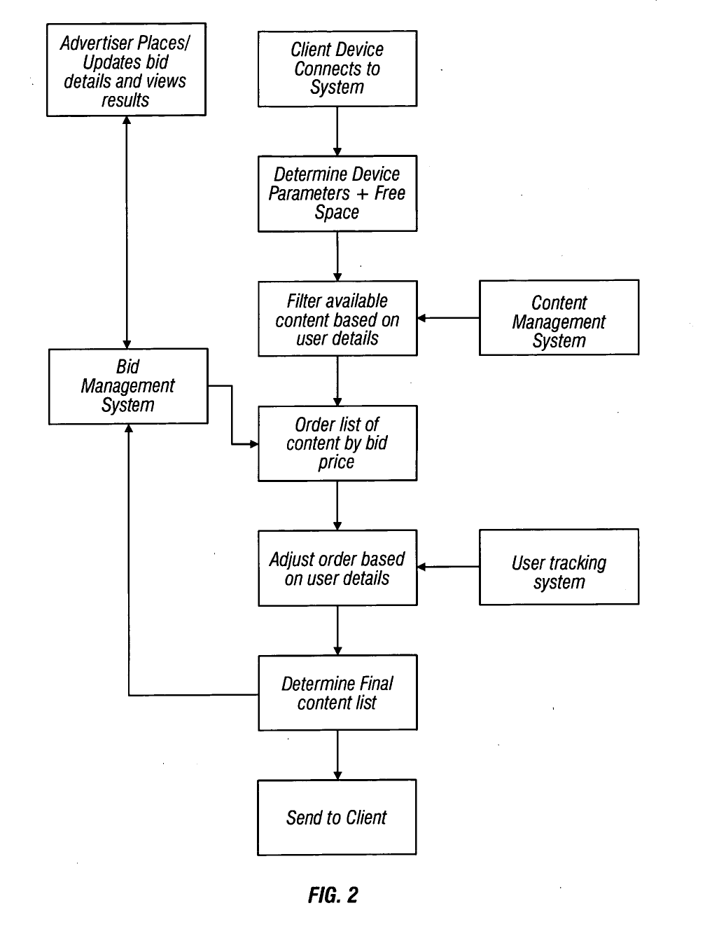

FIG. 3 is a flow chart illustrating a high level view of a communication between a client and the host server of the present invention.

FIG. 4 is a flow chart illustrating one embodiment of method of delivering advertising to a client at a portable device in one embodiment of the present invention.

FIG. 5 is a flow chart illustrating the use of loyalty cards in one embodiment of the present invention.

### DETAILED DESCRIPTION

Definitions

“Advertiser” shall be used in this document to define anyone placing marketing content, including but not limited to: retailers, agencies, brand marketers, businesses, third parties representing any of the aforementioned groups, or any other individuals or groups that purport to place marketing content.

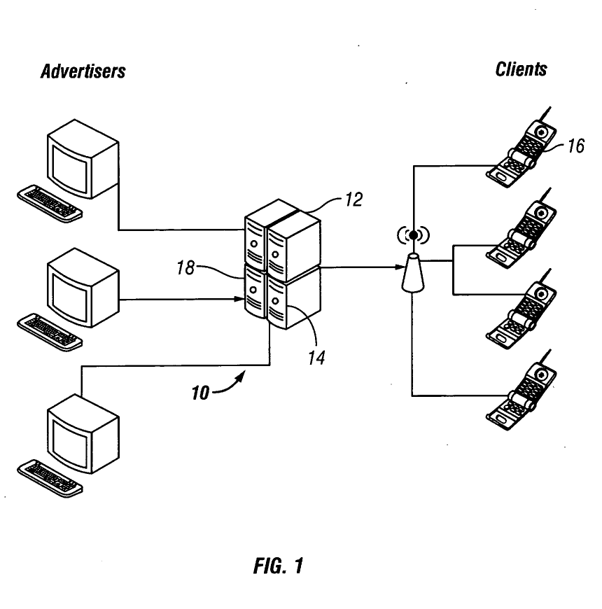

In one embodiment of the present invention, systems and methods are provided for determining a placement order of advertising items that will be displayed at a client's mobile device. Referring to FIG. 1, one embodiment of a host system 10 of the present invention includes a host server 12. The host server 12 including software resources, generally denoted as 14, that are configured to receive advertising items of an advertising campaign from advertisers.

Suitable advertising items include but are not limited to, a list of merchants, special event data, a coupon, an ad, a contest, a loyalty card, and the like. The downloaded advertising items can include both layout and content information.

Such advertising items are intended for distribution to client's mobile devices 16. Suitable mobile devices 16 include but are not limited to a, cell phone, PDA's, smart devices, personal portable devices and the like. This can be implemented over a network connection, downloaded via cable or over a BLUETOOTH connection, come preinstalled by the phone OS manufacture or distributor, and the like.

The advertiser selects the advertising item content that it wishes to place a bid value on. A subset of parameters is then selected for the advertising item content and a bid amount is placed for each placement order.

The host system 10 receives the advertising items to be displayed and creates a placement order of the advertising items that will be forwarded for distribution. to the client's mobile devices 16. A recommendation engine 18 can be included that is coupled to the software resources. The recommendation engine 18 makes a determination of placement order of advertising items to be received and displayed at the client's mobile devices 16. In one embodiment, the determination made by the recommendation engine 16 also includes at least one of, client demographic descriptions, client product preferences, psychographic data, location of advertiser, location of client software, category of advertiser and other client patterns

In one embodiment, the host system calculates the cost of the advertising campaign. Advertisers are then billed for the cost of the advertising campaign.

The software resources can determine placement order by hosting a bidding auction using a web interface to provide advertisers or their agents bidding opportunities for advertising item placement order from their own computers. The bidding auction can be in fixed or non-fixed amounts of time to bid on a placement. Suitable periods of time include but are not limited to an hour, a day, 3 days, a week or more. In addition it could not have a cutoff but rather run until outbid. The placement order is typically calculated by the host system 10 for each request of an advertising item from a client.

The advertiser can influence a higher ranking of advertising placement, based upon the competitive bidding process. A higher bid by an advertiser will likely result in a higher placement.

Advertisers can choose to purchase higher rankings within certain demographic or psychographic categories of individuals who have the client software. Advertisers can also choose to purchase higher rankings within particular categories of advertisements (such as particular type of retailer). Advertisers can also choose to purchase higher rankings within particular locations of retailers or particular locations of individuals who have the client software, as more fully discussed below.

The placement order can be based on a dollar amount paid to place the advertising item that will be delivered to the client's device 16. An amount bid for the placement order by the advertiser can be an influencer of placement. The actual placement order can be at least partially determined by at least one of, client habits, client demographic information, client interest and the like

In response to a request for discounts to be displayed, a determination is made based on current data what discounts to deliver and their placement order. In one embodiment, advertising content delivery is based on a current bid of the advertiser, how much the advertising will pay and a comparison of bids with other advertisers.

Placement can be automatically adjusted by the host system 10. This automatic adjustment of the placement order can be in response to at least one of, client demographics, client product preferences, client psychographic data, geographic location of clients, location of the advertiser, location of client software, category of advertiser and other client patterns. The host system 10 can download and dynamically update a client interface to display the updated rankings. This can include modifications of the appearance of advertisements, such as by color, by size, by motion, or other graphical means.

Typically, an advertiser pays a lowest amount necessary for a desired placement order position. Bidding can occur within other categories including but not limited to, demographic descriptions, product preferences, psychographic data, location of advertiser, location of client software, geographic regions, category of advertiser and client usage patterns. Bids can be for fixed or non-fixed periods of time.

The amount bid by the advertisers can be used as a factor for the time period of the placement order. The host system 10 can maintain advertiser contact and billing information. Individual accounts can be created by the host system to conduct the placement order for each advertiser.

The host system 10 can notify client's of buying opportunities available through the client's mobile device 16 after or before it has made a placement order decision.

The host system 10 can provide a real time estimate of how many screens will be displayed for the advertising item. This estimate can broken down by segments including but not limited to client demographics, client product preferences, client psychographic data, geographic location of clients, location of the advertiser, location of client software, category of advertiser and other client patterns.

The advertiser's inventory management or customer tracking system, and the like, can automatically place or updating placement order bids in real time.

In one specific embodiment, an advertiser contacts the host system 10 to indicate the kind of discount the advertiser has to offer and/or deliver as well as the time frame for the discounts.

The host system 10 makes a determination about the amount of content that can be stored and displayed on the client's mobile device 16. A determination is made by the host system 10 about the amount of new data that the client's mobile device 16 is capable of receiving. The host system calculates the amount of data that was already been delivered to the mobile device as we as the total number of coupons or ads that are still active. It compares these values against previously set storage limitations of the device and limitations in Ul to display the correct number of coupons or ads. These values can be affected by the total amount of available space on the client, the read/write speed of the memory used in the client, the screen size and resolution of the client and other factors. The host system does this in order to insure that the client's mobile device 16 has the capacity to receive the advertising items and display them correctly.

The host system 10 ignores content that should not be delivered to the client and then creates a bid value for advertising item content that can be delivered to the client. Ignored content can include content that is not valid any longer, has expired, has been delivered to the maximum number of clients possible, has reached the maximum the advertising is willing to pay or for other reasons.

The host system 10 adjusts the placement order by how well the content fits a client's demographics. The host system 10 can adjust the placement order by determining how well advertising item content fits a client's profile. The placement order can also be adjusted by using preferences set by the client in terms of advertising item content. Each content is given a score based upon a combination of the bid values, the demographic fit, specific client requests and other criteria. The host system 10 then selects the top content items up to the maximum previous calculated that will fit on the client's mobile device. These top items are then delivered to the client's mobile device and the advertisers account is charged accordingly.

The exact amount that is charged can depend on the advertisers bid amount, the bid amount of other advertisers, how well the delivered content fit the target demographic and other factors. In addition there can be addition charges depending on the client's interactions with coupon or ad, including viewing or using it, passing it on to a friend or other behaviors.

The host system 10 can bill the advertisers in a variety of different ways, including but not limited to, automatically billing, mailed bill, email bill and the like. The automatic billing can occur by, charging a credit card on file, sending a bill, debiting a bank account, charging a paypal or other third party account, debiting a cash balance stored in the host system 10, debiting credit given for some other reasons and the like . Credit could have-been given for driving client traffic to a website of the advertiser, diving client registration in the host system 10, and driving clients to be active with the host system 10 or other reasons.

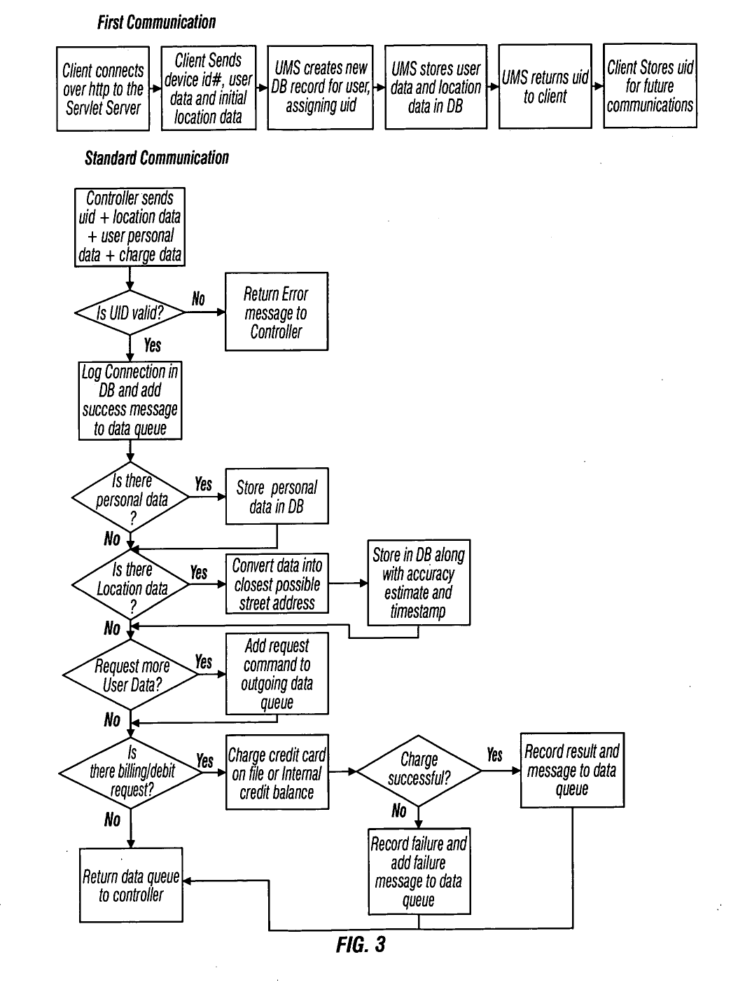

To initiate downloading to a client, a client ID is sent to the host server 10. A downloaded advertising item is produced relative to a product or service from the host server, as illustrated in FIG. 3. The downloaded advertising item is parsed and stored by the hose system. The host system 10 then sends advertising items to the client's portable device 16 in a placement order.

When the client first starts an application, a network connection with the host server begins in the background. This network connection reaches the host server both to upload and download data. All logged information is uploaded, including but not limited to each advertising item, such as a coupon, used, deleted and viewed by the client and how often. The amount of free space available on the client's portable device is also uploaded. Addition data can be attached including but not limited to the current GPS coordinates of the client's portable device. Client requests are uploaded. By way of illustration, and without limitation, these client request can include, requests to install the client on a different portable device, specifically requested advertising items, personal data entered, and the like. Advertising items can be requested by entering a short code, waving a BLUETOOTH enabled device over a transmitter, taking a picture of a code, such as a barcode or other machine readable picture, with the client's portable device's built in camera. This can then be translated into a code to be uploaded, received as an IR signal via an IR receiver or any other reasonable input method into the client's portable device.

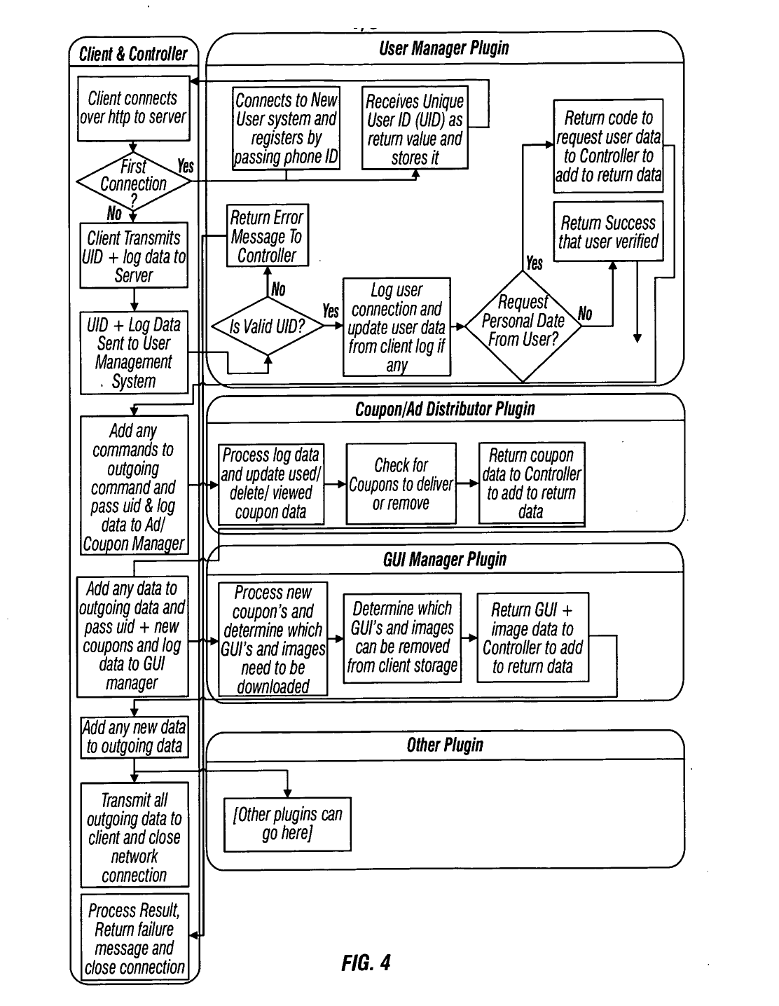

As shown in FIG. 4, the client can link its loyalty card or information to the host server, through their portable device, and the like. The portable device, and the like, is used to provide the client ID at the point of sale. The loyalty data linked to the ID can be used by the host server to provide custom content, including but not limited to, discounts, special events, and the like, in response to the client's previous purchasing history. The client's portable device can be used to track a client's progress towards a goal, e.g., but 10, get the 11^{th} free, and the like.

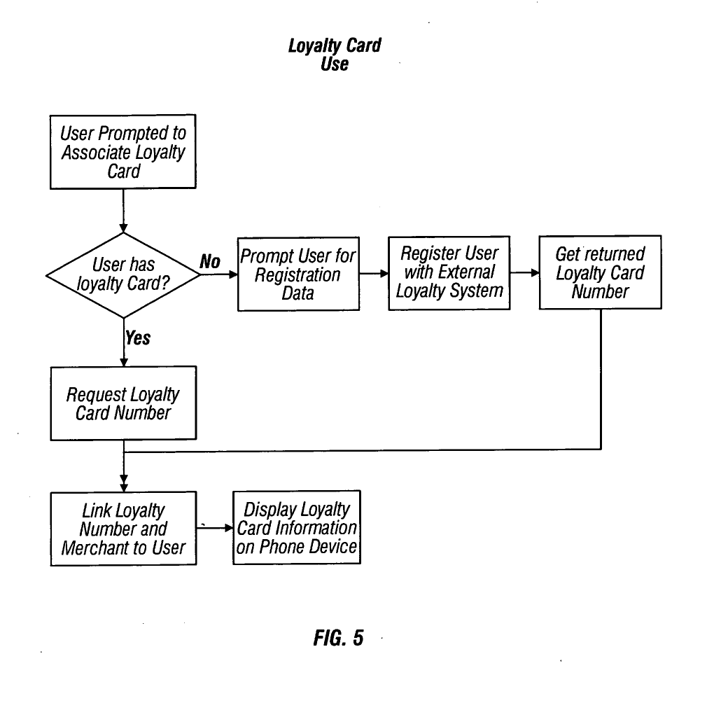

A portable device application is downloaded from the host computer and installed on the client's portable device. An application can be run by the client that is prompted for the client's personalized information. Such personal information can include, but it not limited to the client's, zip code, age, gender, address, contact information, preferences, and the like. One instance of how the initial flow can work can be seen in FIG. 5.

In producing the downloaded advertising item, data of the client's actions and the client's non-actions is processed at the server from previous client activity. The client's actions and non-actions for the advertising item are then updated and storing it at the host server. In response to the updating, the new advertising item is sent to the client.

During parsing, the host server can pre-format the advertising item for easier client use. By way of illustration, and without limitation, the host server can place the content to be delivered in a specific fixed order, delimited by a special character. The client can then easily iterate across this list, parsing and placing each element into an array in the same order. The client can use the same previous knowledge about the order to index into that array, to load any specific element. The data in the same form can be stored for later retrieval using the same method.

The data can be transmitted in an extremely compact form. By way of illustration, and without limitation, one method is to have a list of values, delimited by a special character, with each addition position representing a different element of data. Further details regarding the delivering of advertising items to the client at the mobile device are found in U.S. patent application Ser. No. 11/349,050, filed Feb. 6, 2006, incorporated herein by reference.

The foregoing description of embodiments of the present invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

1. A method of delivering advertising items to a client's mobile device, comprising:
providing server software at a host system that receives advertising items of an advertising campaign for distribution to clients with mobile devices; and
determining a placement order of advertising items for display at a client's mobile device.

2. The method of claim 1, wherein the host system uses an auction process for determining the placement order of advertising items.

3. The method of claim 1, further comprising:
calculating the cost of the advertising campaign; and
billing the advertiser for the cost of the advertising campaign.

4. The method of claim 1, further comprising:
delivering at least a portion of the advertising item to a client's mobile device for display in a placement order.

5. The method of claim 1, wherein the placement order is determined through a competitive bidding process of bid amounts submitted by advertisers.

6. The method of claim 1, wherein the placement order is based on a dollar amount paid to place the delivered advertising item.

7. The method of claim 1, wherein an amount bid for the placement order is an influencer of placement.

8. The method of claim 1, wherein the actual placement order is at least partially determined by at least one of, client habits, client demographic information and client interest.

9. The method of claim 1, wherein the server software hosts a bidding auction using a web interface to provide advertisers or their agents bidding opportunities for advertising item placement order from their own computers.

10. The method of claim 9, wherein the bidding auction is in a format of a fixed amount of time to bid on a placement.

11. The method of claim 9, wherein the bidding auction is in a format of a non-fixed amount of time to bid on a placement.

12. The method of claim 5, wherein the placement order is calculated for each request of an advertising item from a client.

13. The method of claim 5, wherein in response to a request for discounts to be displayed, a determination is made based on current data what discounts to deliver and their placement order.

14. The method of claim 9, wherein advertising content delivery is based on a current bid of the advertiser, how much the advertising will pay overall for a defined increment of time and a comparison of bid.

15. The method of claim 9, wherein bids can automatically be adjusted.

16. The method of claim 15, further comprising:
automatically adjusting the placement order in response to at least one of, client demographics, client product preferences, client psychographic data, geographic location of clients, location of the advertiser, location of client software, category of advertiser and other client patterns

17. The method of claim 9, wherein an advertiser pays a lowest amount necessary for a desired placement order position.

18. The method of claim 9, wherein bidding occurs within other categories.

19. The method of claim 18, wherein the other categories are selected from at least one of, demographic descriptions, product preferences, psychographic data, location of advertiser, location of client software, geographic regions, category of advertiser and client usage patterns.

20. The method of claim 1, wherein a term for a specific placement order is for a fixed period of time.

21. The method of claim 1, wherein a term for a specific placement order is for a non-fixed period of time.

22. The method of claim 5, wherein the amount bid is used as a factor for the time period of the placement order.

23. The method of claim 6, wherein the server software delivers the bid amounts to a recommendation engine.

24. The method of claim 23, wherein the recommendation engine makes a determination of placement order that is received by client software.

25. The method of claim 23, wherein the determination made by the recommendation engine also includes at least one of, client demographic descriptions, client product preferences, psychographic data, location of advertiser, location of client software, category of advertiser and other client patterns

26. The method of claim 4, wherein the displayed advertising item includes at least one of, a list of merchants, special event data, a coupon, an ad, a contest, and a loyalty card.

27. The method of claim 4, wherein the displayed advertising item includes layout and content information of the advertising item.

28. The method of claim 1, further comprising:
maintaining advertiser contact and billing information.

29. The method of claim 1, further comprising:
creating an individual account to conduct the placement order for each advertiser.

30. The method of claim 1, further comprising:
notifying client's of buying opportunities available through the client's mobile device.

31. The method of claim 1, further comprising:
selecting, by the advertiser, advertising item content to place a bid value on.

32. The method of claim 31, further comprising:
selecting, by the advertiser, a subset of parameters for the advertising item content; and
indicating, by the advertiser, a bid amount for each placement order.

33. The method of claim 1, further comprising:
providing a real time estimate of how many screens will be displayed for the advertising item.

34. The method of claim 33, wherein the estimate is broken down by segments.

35. The method of claim 1, further comprising:
automatically placing or updating placement order bids in real time by an advertiser's inventory management or customer tracking system.

36. The method of claim 35, wherein an advertiser contacts the host system to indicate the kind of discount the advertiser has to offer.

37. The method of claim 36, wherein the advertiser contacts the host system and indicates how many discounts the advertiser has to deliver.

38. The method of claim 37, wherein the advertiser contacts the host system and indicates in the time frame for the discounts.

39. The method of claim 1, further comprising:
determining an amount content that can be stored and displayed on the client's mobile device.

40. The method of claim 39, further comprising:
determining an amount of new data the client's mobile device is capable of receiving.

41. The method of claim 40, further comprising:
Ignoring content that should not be delivered to the client prior to sending advertising items to the client.; and
creating a bid value for advertising item content that can be delivered to the client.

42. The method of claim 1, further comprising:
adjusting the placement order by how well the content fits a client's demographics.

43. The method of claim 1, further comprising:
adjusting the placement order by determining how well advertising item content fits a client's profile.

44. The method of claim 1, further comprising:
adjusting the placement order by using preferences set by the client in terms of advertising item content.

45. The method of claim 1, wherein the host system automatically bills the advertiser.

46. The method of claim 1, wherein the host system automatically bills the advertiser by at least one method selected from, charging a credit card on file, sending a bill, debiting a bank account, charging a paypal or other third party account, debiting a cash balance stored in the host system and debiting credit given for some other action.

47. The method of claim 46, wherein the other action is selected from, driving client traffic to a website of the advertiser, diving client registration in the host system, and driving clients to be active with the host system.

48. A system for delivering advertising items to a client's mobile device, comprising:
a host system that includes a host server, the host server including resources configured to receive advertising items of an advertising campaign from advertisers for distribution to clients with mobile devices and a recommendation engine, the recommendation engine making a determination of placement order of advertising items to be received and displayed at the client's mobile device.

49. The system of claim 48, wherein the determination made by the recommendation engine also includes at least one of, client demographic descriptions, client product preferences, psychographic data, location of advertiser, location of client software, category of advertiser and other client patterns.
